(19) United States
(12) Patent Application Publication
(10) Pub. No.: US 2007/0005373 A1
(43) Pub. Date: Jan. 4, 2007

(54) Computerized agent and systems for automatic searching of properties having favorable attributes

(76) Inventors: Mario A Villena, Miami, FL (US); Jose Villena, Miami, FL (US)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 10/536,693

(22) PCT Filed: Aug. 31, 2004
(86) PCT No.: PCT/US04/28206

§ 371 Date: Aug. 4, 2006

(51) Int. Cl. G06Q 99/00

(52) U.S. Cl. 705/1

(57) ABSTRACT

An electronic agent for performing property-related searches and notifications based on search parameters provided by a user includes a first device configured to receive information about residential properties and a second device configured to receive information from the first device about a first property determined to be offered for sale, and determine whether the first property conforms to a differential valuation. In various embodiments, the differential valuation can be based on an offering price of the first property, an AVM generated value of the first property and one or more AVM-related user-provided parameters.

### FIELD OF THE INVENTION

This disclosure relates to a computer-based agent for detecting property anomalies.

### BACKGROUND OF THE INVENTION

Real estate is a multi-billion dollar industry touching virtually every strata of our society. Although the industry has consolidated somewhat during the last ten years, it remains highly fragmented. Unfortunately, the “power to transact” is largely concentrated in the hands of real estate brokers and agents regardless of the fact that entry and exit barriers are low. Further, the range of available buying and selling options are limited since the services provided by practically every real estate professional are virtually the same throughout the entirety of the United States and beyond.

Unfortunately, the real-estate industry has been highly resistant to the threat of new and potentially disruptive technologies as consumer behavior have been almost completely ignored. While a number of new computer-based tools are under development or have been proposed, their effect has either been inconsequential or specifically designed to preserve the status quo of the real estate industry, rather than directed to transform the industry to the benefit of property owners. Accordingly, new technological approaches relating to real estate are desirable.

### SUMMARY OF THE INVENTION

In one aspect, an electronic agent for performing property-related searches and notifications based on search parameters provided by a user includes a first device configured to receive information about residential properties and a second device configured to receive information from the first device about a first property determined to be offered for sale, and determine whether the first property conforms to a differential valuation. In various embodiments, the differential valuation can be based on an offering price of the first property, an AVM generated value of the first property and one or more AVM-related user-provided parameters.

In another aspect, an electronic agent for performing property-related searches and notifications based on search parameters provided by a user includes an AVM database containing AVM-generated values for substantially every residential property in a definable geographic region, a first device configured to receive information about residential properties as they are initially offered for sale and a second device configured to notify the user based on user-provided parameters, the offering price of the first property and at least one AVM entry in the AVM database.

In yet another aspect, an apparatus for predicting the sale date of a property includes a memory containing information about an identified property, the information including: an AVM-generated value of the identified property and the offering price of the identified property. The apparatus can also include a processing device that generates a sales profile for the identified property based on the offering price and the AVM generated value, the sales profile including a likely sale date.

In still another aspect, a storage medium contains a number of instructions that when accessed by a computer can enable the computer to perform agent-related services for a user. The storage medium can include a first set of one or more instructions for receiving information about one or more first residential properties as they are initially offered for sale, and a second set of one or more instructions for determining whether the first residential properties conform to a differential valuation, the differential valuation being based on an offering price of the first property, an AVM generated value of the first property and one or more AVM-related user-provided parameters.

There has thus been outlined, rather broadly, certain embodiments of the invention in order that the detailed description thereof herein may be better understood, and in order that the present contribution to the art may be better appreciated. There are, of course, additional embodiments of the invention that will be described or referred to below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 depicts a networked system capable of allowing users to access AVM technology.

FIG. 2 is a block diagram of a system capable of performing AVM-related services.

FIG. 3 depicts various geographic regions of interest.

FIG. 4 depicts AVM database information.

FIG. 5 depicts a parameter-setting page.

FIG. 6 depicts a first reporting page.

FIG. 7 depicts a second reporting page.

FIG. 8 is a flowchart outlining an exemplary operation for performing AVM-related services.

### DETAILED DESCRIPTION

Automated Valuation Methodology (AVM) is a computer-based technology that has been used to determine the market value of real estate for nearly a decade. Unfortunately, AVM technology is very expensive. As a result, the available AVM providers are generally limited to a very few large corporations. The downside of having such limited pool of AVM providers keeps the price extremely high and the availability extremely limited. For example, one web-based service will provide an AVM valuation of a specific residential property for $25. While this may be appropriate if one desires to look at a limited number of properties or determine a mortgage limit for a specified property, its utility as a market analysis tool to the small investor is practically nil as performing a comparative analysis of properties in even a small geographic can cost tens of thousands of dollars.

Another downfall of the limited availability of AVM providers is quality. In an study of four AVMs, Standard & Poor's found that, while known AVM can (in many circumstances) provide decent property estimates, known AVM systems are documented as over-estimating property values by as much as two-hundred percent. As a result of the spotty nature of AVMs, lenders are forced to continue to rely heavily upon appraisers, who in turn rely on what is known as the “Appraisal Institute Residential Database” (AIRD). As the AIRD is basically of use only to professional appraisers and only for specific identified properties, its usefulness as a marketing tool to the small investor is also practically nil due to the high expense of the human element.

In view of these circumstances, the inventors of the disclosed methods and systems have created an entirely new approach to empower buyers and sellers of real estate property. Against industry trends and traditions, the inventors have invested greatly in their own AVM technology, and applied it in unconventional and novel ways. Accordingly, the inventors have a unique standing in the relevant industry with the ability to perform massive numbers of AVM valuations at negligible costs. As a result, the inventors have created novel applications that can take advantage of the strengths of AVM technology while limiting their known liabilities. For example, by employing AVM technology not against various specific properties, but against practically every property in a given geographical region, entirely new approaches for investing can be formulated with negligible costs and before any substantial money is ever invested by a given consumer.

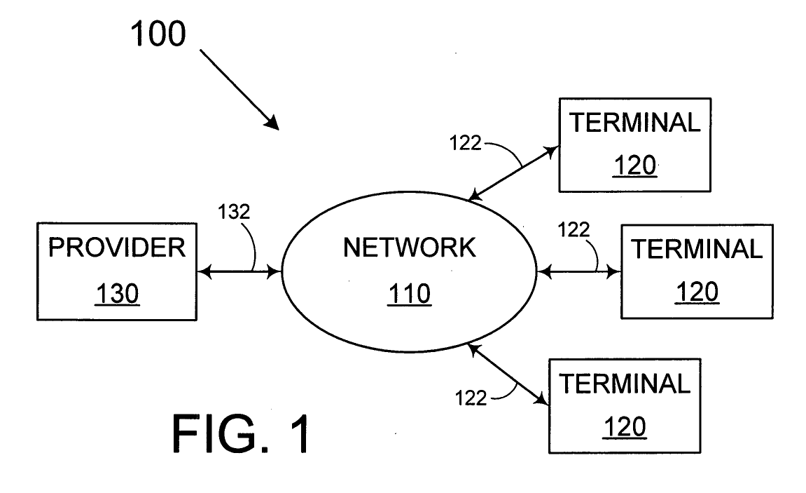

FIG. 1 depicts an exemplary networked-system 100 configured to enable individual consumers/investors to effectively utilize AVM technology. As shown in FIG. 1, the networked-system 100 includes a provider 130 coupled to a network 110 via link 132, as well as a number of terminals 120 coupled to the network 100 via respective links 122.

In operation, the provider 130 can work according to two different schemes: as an on-line tool and as an automated agent.

In operating as an on-line tool, the provider 130 can first perform a number of set-up operations, such as creating and maintaining a database of all (or substantially all) known properties in a particular geographical region, performing an AVM valuation of such properties and identifying all such properties that are offered for sale. Once the appropriate information is amassed and prepared, the provider 130 can service anyone who may desire to employ any of a number of property-related services made available by the provider 130. In the present embodiment, such services can be accessed using any of the available terminals 120.

The terminals 120 of the immediate example are personal computers capable of interfacing with a network. However, in various embodiments the terminals 120 can include any of a variety of communication devices, such as personal computers, PDAs, telephones and cell-phones (with and without graphic displays), television sets with special two-way interfaces or any other known or later-developed communication device capable of communicating with an automated service provider without departing from the spirit and scope of the present disclosure.

The exemplary provider 130 is a computer-based server capable of accessing the Internet. However, as with the terminals 120, it should be appreciated that the provider 130 can take any number of forms, such as a server, a personal computer, a mainframe and so on.

The exemplary network 110 is a publicly available portion of the Internet. However, in other embodiments the network 110 can be any viable combination of devices and systems capable of linking computer-based systems including a wide area network, a local area network, a connection over an intranet or extranet, a connection over any number of distributed processing networks or systems, a virtual private network, the Internet, a private network, a public network, a value-added network, an intranet, an extranet, an Ethernet-based system, a Token Ring, a Fiber Distributed Datalink Interface (FDDI), an Asynchronous Transfer Mode (ATM) based system, a telephony-based system including T1 and E1 devices, a wired system, an optical system, a wireless system and so on.

The various links 122 and 132 of the present embodiment are a combination of devices and software/firmware configured to couple computer-based systems to the Internet over a wired line. However, it should be appreciated that, in differing embodiments, the links 122 and 132 can take the forms of modems, networks interface card, serial buses, parallel busses, WAN or LAN interfaces, wireless or optical interfaces and the like as may be desired or otherwise dictated by design choice.

Returning to FIG. 1, once the provider 130 has performed the above-mentioned initial tasks, the provider 130 can then provide a variety of services to potential users via the terminals 120. In order to service such users and enable various features, the provider 130 of the present embodiment can provide a number of web-pages formatted using HTML, XML, Flash or any other viable publishing standard, such that users accessing the web-pages can do so using nothing more than a commercially available web-browser. However, it also should be appreciated that the provider 130 can also use any number of standardized or specially designed software packages as may be necessary or otherwise desired under a given set of particular circumstances. For example, users accessing the provider 130 using a telephone might use a VoiceXML interface, users accessing the provider 130 using a PDA or FAX-based interface might use a custom program and so on.

A first available service provided by the provider 130 includes the capacity to allow users to query its databases to identify and list all real properties in a given geographic region (such as a region defined by a zip-code, a state, city or county, a school zone, a housing development etc) as well as identify all known properties offered for sale in such region. The provider 130 can further perform queries to identify different types of properties (e.g., single-family dwellings, townhouses, condos, duplexes etc), identify properties based on sale price, tax valuation, number of bedrooms, number of bathrooms, acreage or any other aspect of a property that a consumer/investor might care about and that can be described on a computer medium.

Additionally, the provider 130 can perform queries and identify properties based on AVM valuation. For example, given that the provider 130 can access a database of substantially all known properties in a particular city, and given that the database contains an AVM value for each property, the provider 130 could identify all properties within the city having an AVM value between $150,000 and $100,000, identify all townhouses having an AVM value between $150,000 and $100,000 and so on.

Still further, the provider 130 can perform a “Differential Valuation Search” (DVS) to identify properties based on both their respective AVM values and sale prices. That is, a particular user may wish to identify various properties in a particular region that are offered for sale at a price substantially below their AVM values. For example, by formulating a query to include a preferred school district and an interest in townhouses that are offered for sale at a price at least 20% below their respective AVM values, the provider 130 can appropriately respond and identify any such properties with but a short wait and modest fee.

In the present embodiment, the provider 130 can identify such properties by issuing a literal list of such properties in any number of ordered ways, e.g., ascending/descending sale prices, ascending/descending AVM values, ascending/descending DVS values etc. In other embodiments, however, results can be reported using any combination of lists, graphics (e.g., maps), voiced responses (using, for example, VoiceXML technology) and so on.

In addition of a percentage-based DVS query, the provider 130 can also perform DVS queries based on the absolute difference in sale price and AVM value. Still further, DVS queries can be formed based on a “modified absolute difference” in sale price and AVM value, i.e., the absolute difference discounting various financial factors, such as condo fees, insurance rates, tax assessments, reported utility rates or any other known or later acknowledged item that can affect the investment value of a property. For instance, while a particular user may wish to identify all single-family dwellings in a city that are for sale for at least $10,000 below their AVM value, the user may desire to discount, change the ordering of, highlight or completely eliminate properties that might pass the differential valuation requirement but are encumbered by housing association fees, unusual insurance requirements, reside in high-crime neighborhoods and so on.

Another optional feature of the provider 130 is its ability to perform AVM or DVS searches on dissimilar properties to compare unlike properties for value. For example, a user may wish to identify all condos of a specific type (e.g., 2 bedrooms, 2 bathrooms and 1200+sq ft) in a specific price range with a DVS of 20% simultaneously with all single-family dwellings of a given DVS (or AVM) range having at least three bedrooms and located on at least two acres. By allowing such complex queries, the provider 130 can issue important financial data to investors thus allowing them to compare and contrast various investment opportunities, as well as present attractive options to potential buyers more interested in living in one of several types of (well-priced) properties than investing merely for profit.

As mentioned above, the provider 130 can work according to two different schemes: as an on-line tool and as an automated agent. Further disclosure about on-line operations can be found in U.S. patent application Ser. No. ______ filed on ______ to Mario Villena and Jose Villena entitled “COMPUTERIZED SYSTEMS FOR AUTOMATIC EVALUATION OF REAL ESTATE HAVING VARIOUS OPTIONAL SPECIALIZED COMMUNICATIONS INTERFACES”, the substance of which is incorporated by reference in its entirety.

Regarding the automatic agent-mode of operation, it should first be appreciated that some or all the base functionality available in the on-line mode can be available in the agent-mode, and that some or all the base functionality described in the agent-mode can be available in the on-line mode. However, it should also be appreciated that the agent-mode includes a variety of set-up features and special interfaces that can allow a user to be notified about any desired information practically the moment such information is publicly available on the market, as well as take advantage of communication techniques that may or may not be applicable with on-line tools.

For example, in agent-mode operation or in on-line mode, a prospective user might first be required to register with the provider and/or enter some form of identification and password information to initially access the provider's utilities. Similarly, in either agent or on-line mode a user can form and submit a set of query parameters to include structural information, geographic information, AVM information and so on. However, because an agent can work independently of a user, it can be useful for an agent residing in the provider 130 to initiate contact with a user over a variety of media. For instance, assuming that an agent determines that a property meets the criteria set by particular user and the property appears markedly undervalued. Rather than wait for the user to assert communication, the agent can initiate contact with any terminal 120 accessible to the user, including terminals supporting email, instant messaging, facsimile, telephone contact/voicemail, special pop-up windows and so on. Other forms of communication available can include communication by phone, by standard mail, by telegram or any other known or later developed communication technology that can manipulated by an computer or automated agent.

In addition to using novel means to notify or initiate contact simultaneously over a number of terminals, an agent of the exemplary provider 130 can receive instructions and pass information to a user in new ways. For example, assuming that an agent has identified a particular set of properties that conform to a particular users query, the agent can send alerts/notifications simultaneously via email, pager and instant messaging. The user, responding to his pager, may make contact with the agent via a telephone and, using voice commands, can identify himself and instruct the agent to fax the information to a number presently (or previously) specified by the user as well as download a map with driving instructions to the user's wireless PDA. The agent, in turn, can electronically generate the requested fax as well as download the appropriate information to the PDA.

An advantage provided by the above-described provider/agent and interfaces is that it can be possible to decrease the chances that a particular well-priced property can go unnoticed before the opportunity is usurped by another buyer.

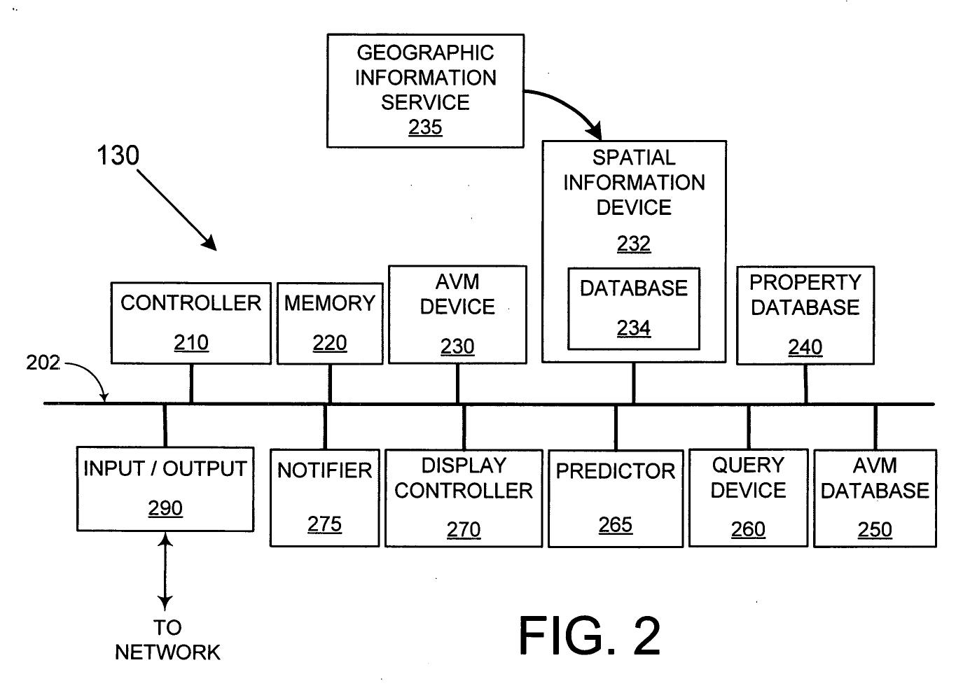

FIG. 2 is an exemplary provider 130 capable of providing a variety of agent-oriented property related services including services that use AVM technology. As shown in FIG. 2, the exemplary provider 130 includes a controller 210, a memory 220, an AVM device 230, a spatial information device 232 (with optional spatial database 234) supported by a Geographical Information Service (GIS) 235, a property database 240, an AVM database 250, a query device 260, a predictor 265, a display controller 270, a notifier 275 and an input/output device 290. The above components 210-290 are coupled together by control/data bus 202.

Although the exemplary provider 130 of FIG. 2 uses a bussed architecture, it should be appreciated that any other architecture may be used as is well known to those of ordinary skill in the art. For example, in various embodiments, the various components 210-290 can take the form of separate electronic components coupled together via a series of separate busses.

Still further, in other embodiments, one or more of the various components 210-290 can take form of separate servers coupled together via one or more networks. Additionally, it should be appreciated that each of components 210-290 advantageously can be realized using multiple computing devices employed in a cooperative fashion. For example, by employing two or more separate computing devices, e.g., servers, to provide spatial information for each computing device used to make AVM calculations, a processing bottleneck can be reduced/eliminated and the overall computing time to produce AVM valuations and other services can be drastically reduced.

It also should be appreciated that some of the above-listed components can take the form of software/firmware routines residing in memory 220 and be capable of being executed by the controller 210, or even software/firmware routines residing in separate memories in separate servers/computers being executed by different controllers. Further, it should be understood that the functions of any or all of components 230-270 can be accomplished using object-oriented software, thus increasing portability, software stability and a host of other advantages not available with non-object-oriented software.

In operation, the provider 130 can first perform a number of setup operations including populating the property database 240 with information about every property within a geographic region of interest as well as identify which properties are offered for sale and the method of sale (e.g., for sale by owner, via an agent etc). While the exemplary provider 130 uses a collection of public and private records (e.g., MLS databases, secondary databases, tax databases, newspaper ads and ads placed specifically with the provider 130) the particular sources of information can vary as required or otherwise found advantageous.

Once the property database 240 is populated, the AVM device 230, under control of the controller 210, can perform an AVM valuation on each property in the property database 240. The exemplary AVM device 230 is based on a combination of heuristic and statistical technologies. However, it should be appreciated that the particular form and functionality of the AVM device 230 can vary from embodiment to embodiment as the technology evolves or as otherwise can be found advantages in various circumstances.

In order to support the AVM device 230, the exemplary provider 130 employs its spatial information device 232 to provide high-resolution spatial data for the various properties of interest, such as high-resolution spatial data including absolute position data, relative position data (e.g., from one property to another), relative direction data etc.

The exemplary spatial information device 232 provides an advantage over conventional AVM systems in that the inventors of the present methods and systems have found a way to reliably and consistently provide absolute and relative spatial information measured in increments of feet (or meters). This is in stark contrast to conventional AVM systems which can only provide distance resolutions literally measured in miles and having negligible, if any, directional information. This is because unlike the exemplary GIS 235, which derives position information using GPS global positioning data to perform high-resolution surveys, conventional systems rely on position approximations based on township, range, section and subdivision information that may or may not be contained in property databases.

While the exemplary spatial information device 232 can provide spatial resolution down to a meter or less, it should be appreciated that more coarse resolutions may be employed with varying degrees of performance. For example, by using a resolution of ten meters, one-hundred meters, two-hundred meters, five-hundred meters and even a kilometer AVM valuation accuracies may be expected to degrade, but may still provide better performance than conventional techniques due to superior resolution, consistency and/or the availability of vector information.

While GIS is a known technology used for land use planning, transportation planning, environmental management and other uses, the exemplary methods and systems are unique in that there are no known instances where a GIS has ever been used for any form of property valuation whether it be by AVM or other means. Similarly, there are no known instances where any form of survey data (by GIS, GPS or other means) has ever been used for any form of property valuation.

In various embodiments, a Geographic Information System can be a combination of computer hardware, software, personnel, survey equipment and data that can enable one to do one or more of store, create, and analyze spatial data. Spatial data can be any information that is referenced to a location. In short, a GIS can be more than a map in that it can hold an underlying database. In order to assure consistent, reliable high-resolution spatial data, the exemplary GIS 235 derives spatial positioning information using survey data, such as survey data derived in part from GPS equipment.

By incorporating a GIS into the exemplary provider 130, a plethora of advantages over other systems are gained, including the availability of a visual representation of the geographic region under analysis. For example, the GIS of the exemplary embodiment can provide a map-like display of objects, such as parcels, schools, police stations, fire hydrants, churches etc. Another advantage to using a GIS is that the above map-like representation is more than a collection of spatially distributed symbols as each symbol/icon has a variety of information associated with it. For example, by referencing a particular “house” symbol, an operator can pull up a host of (1) geographic information, such as latitude, longitude, elevation, county, school district etc, (2) structural information, such as acreage, age, number of bedrooms etc, and various miscellaneous items of information, such as sale history, mortgage etc.

Another advantage of the exemplary system is that it has the ability to highlight on a map the comparables selected for a given target property, and the ability to highlight on a map the comparables selected for AVM valuation.

Still another advantage of the present GIS system is its ability to provide distance calculations down to meters/feet between any two objects as well as directional information. The fine resolution of distances and/or direction can provide an incredible advantage in that, the closer that two structurally comparable houses are, the more likely the sale price of one property will reflect on the value of the other property. Accordingly, the exemplary GIS system can make it possible to weight various sale values as a function of distance in a way that was never possible before.

Additionally, by using true spatial vector information (distance plus angle (or other coordinate system)), AVM calculations can be further refined. For example, if a particular house is structurally comparable to four other houses, and the four houses have values that vary (1) as a function of how far west each house lies and (2) as a function of their proximity to a river or train station, it should be appreciated that high-resolution distance information and angular information may be valuable.

Although the use of GIS (or equivalent spatial) information can be invaluable, processing such information can be relatively expensive in terms of the computation power required to derive accurate AVM valuations via GIS information. As making computationally expensive determinations is rarely acceptable in a web environment, the present AVM system overcomes this problem by pre-processing AVM valuations, preprocessing spatial information and using multiple computer systems to alleviate processing bottlenecks, then allowing users to access some or all of the preprocessed data.

Returning to FIG. 2, as each property in the property database 240 is processed and an AVM value is determined, the AVM device 230 can place the AVM data, along with other data of interest, into the AVM database 250. In the present embodiment, the exemplary AVM device 230 can update the AVM database 250 often and, in some embodiments, can update the AVM database after every sale of a property.

For example, in a particular embodiment, the controller 210 can update the property database 240 to signal that a townhouse in a particular neighborhood recently sold for a given amount of money along with other useful information about the transaction, such as concessions made by the buyer or seller (e.g., points paid by seller) that might better reflect the actual sale value of the property. The AVM device 230 can then subsequently update the AVM values of properties that might be affected by the sale, such as comparable townhouses and other properties in the immediate area, then update the AVM database 250 appropriately.

Other schemes to update AVM databases include periodic update of the entire database, periodic update of classes of properties, e.g., condos of a certain price range, or periodic update of individual properties. Further disclosure about AVM databases can be found in U.S. patent application Ser. No. ______ filed on ______ to Mario Villena and Jose Villena entitled “COMPUTERIZED SYSTEMS FOR FORMATION AND UPDATE OF PROPERTY DATABASES”, the substance of which is incorporated by reference in its entirety.

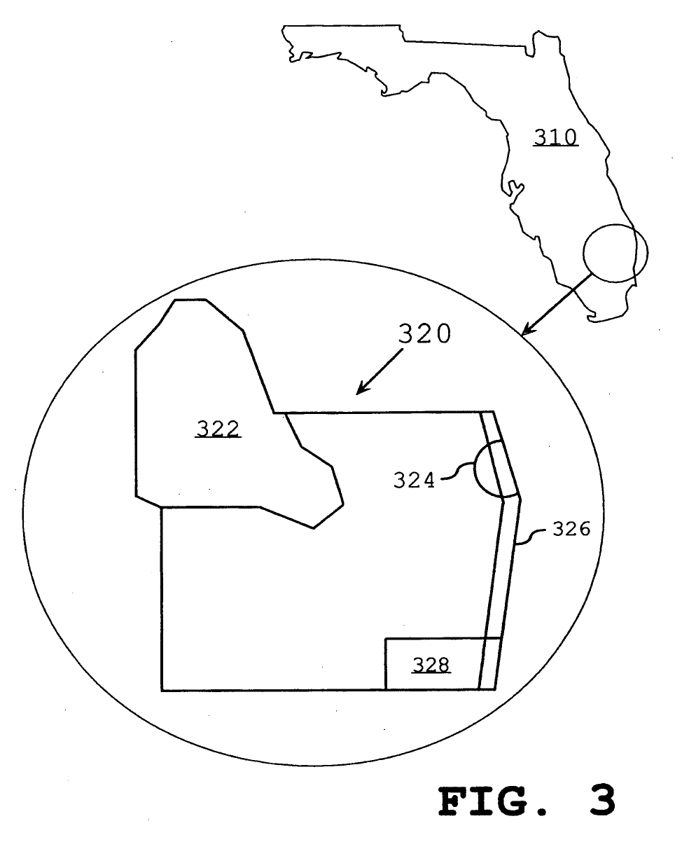

FIG. 3 depicts various types of geographical regions of interest. As shown in FIG. 3, a first region 310 (Florida) can be considered as a definable region of interest as well as a county 320 (Palm Beach). While the county may a better region to work with given its specificity, FIG. 3 shows that the county 320 can be conceptually divided into a zip-code region 322, a region of an incorporated city 324, an exemplary school district 328 or beachfront property 326. Noting that the various regions 310-328 can overlap, it should be appreciated that it can be useful to define regions by multiple, overlapping geographical attributes, e.g., beachfront property 326 found in school district 328.

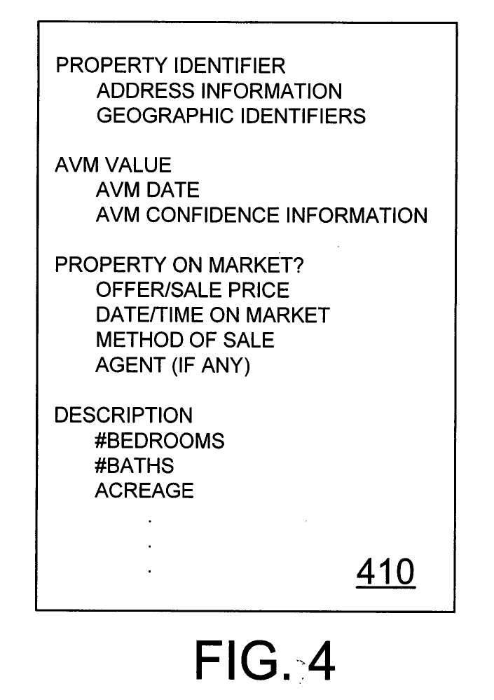

FIG. 4 depicts an exemplary entry 410 of an AVM database, such as the database 250 of FIG. 2. As depicted in FIG. 4, the exemplary entry 410 contains a variety of fields, each of which can have use in executing a query/search of real estate properties. For example, a first useful field can be a “property identifier”, which can be a unique code associated with the property at interest. Other related fields can be the address of the property (which may also serve as a property identifier) and various geographic identifiers, which can serve to provide exact geographic information (latitude and longitude), school district information, zip code, housing development information, zoning information or any other information having geographic significance. Such fields, which can define a wide range of geographic regions can add value to a database by enabling unique geographic searches.

A second group of fields include an AVM value field, the date that the AVM value was calculated and various AVM confidence identifiers, which can provide a measure of confidence as to the accuracy of the AVM value. Such AVM confidence identifiers can include a number of similar properties on the market that have recently sold, a number of similar properties upon which an AVM value was determined and so on. Such AVM confidence identifiers may also consist of a set of one or more codes or values (e.g., a statistical variance) reflecting the above-mentioned (or similar) data.

Other information of interest can include various sale information fields, such as indicators as to whether the property is presently offered for sale, the offering/sale price, the date/time on market, the method of sale (e.g., for sale by owner, bankruptcy sale), the sales agent if any and so on. Still other information can include detailed description information of the property, such as the number of bedrooms, total square feet etc.

Again returning to FIG. 2, it should be appreciated that in view of FIGS. 3 & 4 the available data in the databases 240 and 250 can enable a filtering device, such as the query device 260, to perform AVM-based queries on any number of regions defined by attributes such as a state, a city, a set of nearby cities a county or parish, adjacent counties, a zip code, proximity to a resource (e.g., a beach) or proximity to a specific location (e.g., within a 4 block radius of a train/subway station), a school district, a particular neighborhood, adjacent neighborhoods or a set of neighborhoods, a geographic region governed by a particular government body, a set of geographic regions governed by different government bodies and so on.

It should also be appreciated that the query device 260 might also perform queries based on a geographic region provided by a user, such as a hand-drawn region provided using a computer mouse and a computer-generated map backdrop or area defined by latitude and longitude coordinates.

Still further, it should be appreciated that the query device 260 can perform queries based on certain information regarding the character of the property, such as acreage, type of property, number of bedrooms, etc.

Using the available information provided by the AVM database 250 and the services provided by the query device 260, it should be apparent that users of the provider 130 can identify properties of interest in a large number of new and useful ways.

In the present embodiment and in either on-line or agent-mode, the provider 130 can receive various queries of interest via the input/output device 290 and the display controller 270, which is configured to provide a number of types of interface tools appropriate to the circumstances. For example, assuming that a user desires to create an agent via a web-browser on his personal computer, the display controller 270 can provide a number of appropriate web-pages. Similarly, the display controller 270 can alternatively provide any number of visual or text interfaces for PDAs or other like equipment, voice-based interfaces for phones and so on.

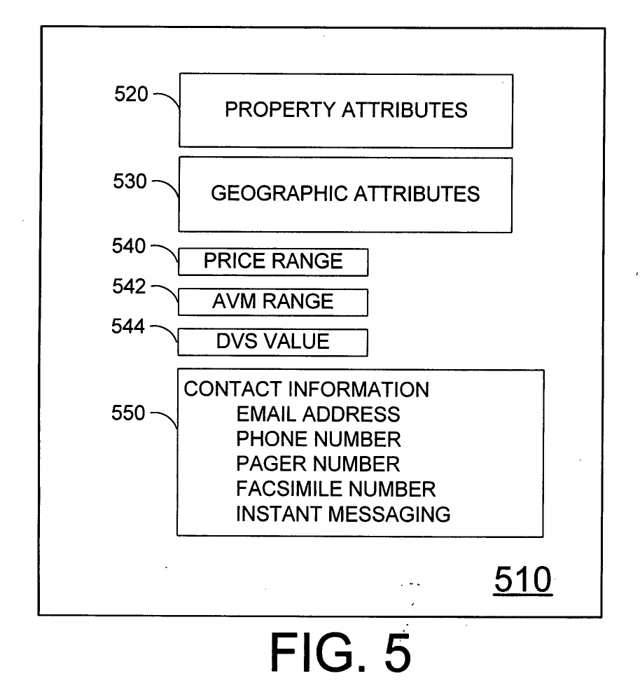

For instance, FIG. 5 depicts an exemplary visual/text-based query parameter web-page 510 that can be used by the provider 130 to gather information pertinent to a query. As shown in FIG. 5, the parameter web-page 510 can contain a number of useful entry fields 520-550, which for the immediate example can consist of any type of known or later developed entry field, such as text-entry fields, selection boxes, virtual switches, logical entry boxes and so on. A first entry field of interest is a property attribute field 520, which can enable a user to select various basic information about a property that might be of interest, such as acreage and number of bathrooms. A second entry field of interest is a geographic attribute page, which can enable a user to select geographical regions of interest down from a particular street to an entire state or possibly more, e.g., a the Southeastern portion of the United States. Other entry fields include a price range 540, an AVM range 542 and a DVS value 544.

In addition to the various query parameters accommodated by fields 520-544, the exemplary parameter web-page 510 can provide a number of contact fields 550, which can enable a software agent, e.g., the provider 130, to interact with a user in a variety of ways, including email, phone, pager, facsimile, instant messaging and so on. For example, by appropriately filling in the various contact information within the contact fields 550, the provider 130 can send initiate contact with a user via a combination of voicemail and pager signals and/or provide extensive information about a particular property via email.

Again returning to FIG. 2, as properties are identified by the query device 260 to be of interest, the query device 260 can provide the information to the display device 270. The display device 270, in turn, can provide a variety of useful displays to a terminal, such as a personal computer, to aid in the review of such properties. In a first embodiment, such a display can take the form of an ordered list, i.e., a literal display. However, even straightforward literal displays can be augmented by hyperlinks to detailed descriptions of respective properties, to maps, to driving directions, to sale histories of the property or comparable/neighboring properties etc.

In addition to literal displays, electronic and printable maps (graphic displays) of one, some or all identified properties can be generated with superimposed icons or with other identifiers representing the identified properties. Such displays can also be augmented by interactive display tools. For example, in a particular embodiment, the display device 270 can provide a “pop up” window to a terminal in order to provide information of interest. For instance, in various embodiments a user accessing the provider 130 via a PC can “click” on a property icon embedded in an electronic map displayed on his screen. In response, the display device 270 can provide a window containing useful information, such as address, sale price and AVM data.

In still other embodiments, the exemplary display device 270 can provide specialized displays and interfaces for use in mobile terminals such that the provider 130 can provide interactive driving directions, which may be especially useful for users having a GPS device integrated into their terminal. Alternatively, the display device may provide comparable audio information including addresses, driving instructions etc, or information that might be displayed on the relatively tiny displays found on many mobile phones and PDAs.

Another feature of the exemplary provider 130 is its notifier 275. The notifier 275 can operate independently or in conjunction with the display controller 270, and has the primary purpose of making quick contact with a user to alert him that important information is available, rather than provide the information itself. For example, suppose that a property comes on the market for 30% below its AVM value and has a predicted time of sale of less than 24 hours. The notifier 275 can generate a brief voice message and call the user, generate and send a fax, send a pager message and so on. In various embodiments, the notifier 275 can be programmed to send a single message or optionally be programmed to send repeated messages or messages until the user responds, in which case the provider 130 can deliver more detailed information.

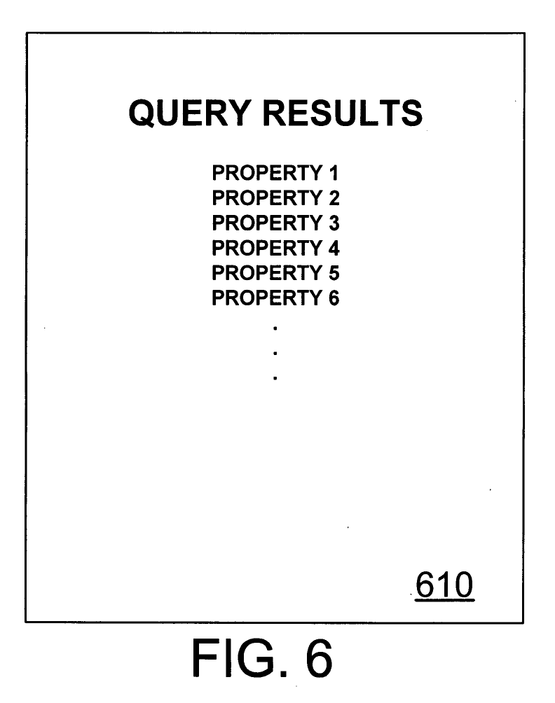

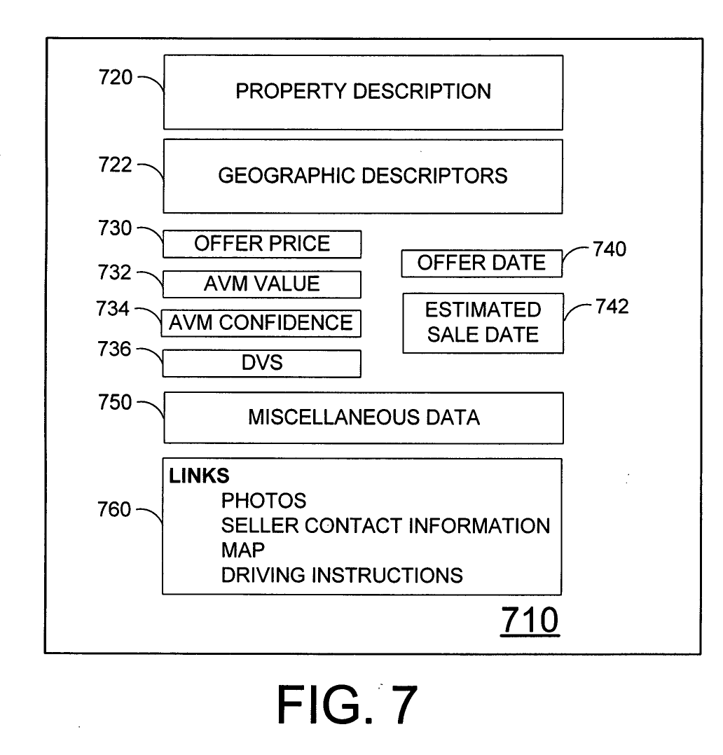

FIG. 6 depicts a first results page 610 that the provider 130 can provide either by on-line web-page, e-mail or any other adequately equipped media. As shown in FIG. 6, the first results page 610 can include a list of properties that meet criteria set by a user. For various electronic media capable of using hyperlinks or other linking technology, a user can further display details relating to individual properties. For instance, FIG. 7 depicts an exemplary second results page 710 displaying information relating to a particular property that may be evoked via electronic link or shown as an attachment to the list of FIG. 6. The exemplary second results page 710 includes a property description field 720, a list of geographic descriptors 722, e.g., county, zip code and school district, the property's offer price 730, the property's AVM value 732, the property's DVS value 736 (in percent and/or absolute dollars), the property's offer date 740 and the property's estimated date of sale 742 (explained below). Other fields of interest may include miscellaneous data 740, which might include subjective notes about the condition of the property, special concessions the seller will make etc.

In addition to the information fields 720-742 listed above, the exemplary results page 710 includes a list of links 750 leading to other useful information, including links to photos, contact information, maps and driving instructions. By activating the various links 750, a user can not only gather greater subjective data about a property, but quickly make contact with the seller and generate a map with detailed driving instructions, thus giving the user unparalleled market access.

Returning to FIG. 2, in addition to performing AVM-related (and other) queries, the provider 130 can also provide an estimate as to when a particular property is likely to sell using the predictor 265. In various embodiments, the predictor 265 can generate a sales profile of a property based on the property's AVM value, offering price, geographic location, structural details and a host of other available data using a combination of heuristic and statistical processing techniques. However, the particular processing approach and particular data used is envisioned as changing from embodiment to embodiment as technology improves or is otherwise found advantageous without departing from the spirit and scope of the present disclosure.

In addition or alternative to using AVM information, the exemplary predictor 265 can also take advantage of directly using the high-resolution spatial information provided by the spatial information device 232. That is, it should be appreciated that property sales can vary drastically along very narrow geographic boundaries or in certain patterns that low-resolution systems could never even recognize. However, using distance and possibly vector information and spatial resolutions of even a few dozen meters, sales trends can be recognized on a block-by-block basis.

The sales profile of the immediate example includes am expected sales date and a variance. However, a sales profile can alternatively take the form of charts with scattering diagrams, statistically and/or heuristically determined graphs.

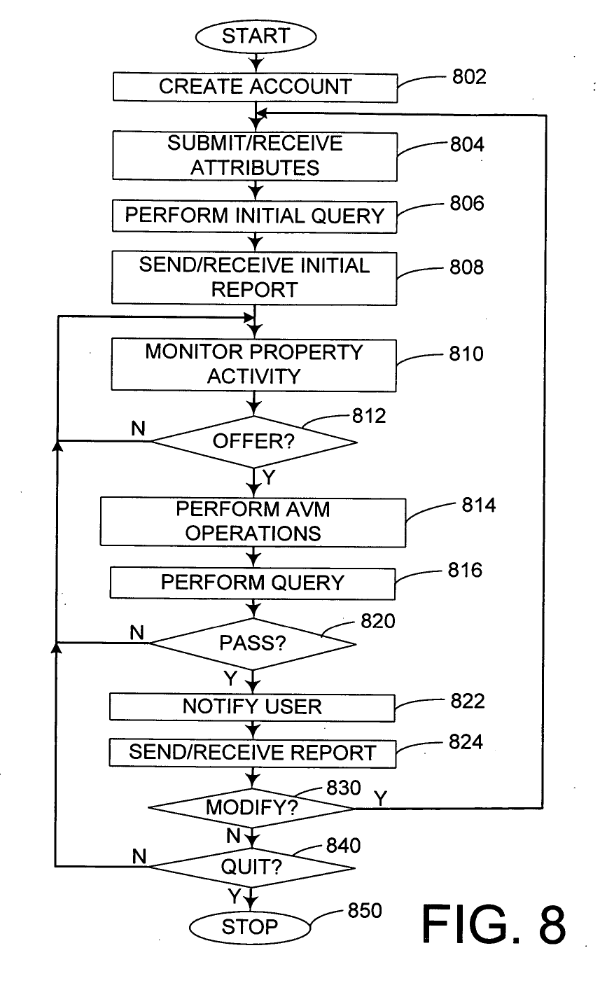

FIG. 8 is a flowchart outlining an exemplary operation according to the present disclosure for using an automated agent designed to perform AVM-related services. The process starts in step 802 where a prospective user creates an account with a computer-based agent. In various embodiments, such an agent can take the form of the provider 130 of FIGS. 1 & 2. However, the particular form of an agent can vary from embodiment to embodiment without departing from the spirit and scope of the disclosure. Next, in step 804, the user can submit a number of query parameters to the agent, including structural parameters for one or more different types of properties, geographic parameters, price and AVM ranges and so on. Once submitted the agent can receive the parameters, control continues to step 806.

In step 806, an initial query is performed using the parameters of step 804. As discussed above, such a query can involve a wide variety of parameters, such as parameters related to structural, geographic and AVM information, and effectively perform various operations, such as tasks equivalent (or substantively similar to) the DVS operations described above and the AVM-based time-to-sale prediction operations. Next, in step 808, the agent can send, and the user can receive, an initial report containing information about all properties that conform to the user's query parameters. In various embodiments, such reports can take the basic form of those reports of the various figures and text discussed above. However, it should be appreciated that the particular form and substance of the initial report can vary as required or otherwise found desirable from embodiment to embodiment. Control continues to step 810.

In step 810, the agent can monitor activity in the real estate market. Next, in step 812, a determination is made as to whether a new property is found to be for sale on the market. If a new property (or properties) is found, control continues to step 814; otherwise, control jumps back to step 810 where market activity is further monitored.

In step 814, a number of AVM operations are performed on the newly identified property to determine AVM values (and related data) in circumstances where there is no existing AVM information on the property identified in steps 810 & 812 or if existing AVM data is determined to be outdated. Using the appropriate existing, updated or newly created AVM information, control continues to step 816 where another query is performed for the newly identified property using the parameters/attributes of step 804. Control continues to step 820.

In step 820, a determination is made as to whether the property passes the query of step 816, i.e., whether the property conforms to the user's desired parameters. If the property passes the query, control continues to step 822; otherwise, control jumps back to step 810 where market activity is further monitored.

In step 822, the user is notified by the agent via any number of communication conduits identified by the user many of which are discussed above. Next, in step 824, the agent can send, and the user can receive, detailed information on the newly identified property again using any number of various communication conduits, many of which are discussed above. Control continues to step 830.

In step 830, a determination is made as to whether the user will modify his query parameters. If the parameters are to be modified, control jumps back to step 804 where the user can submit the new parameters; otherwise, control continues to step 840.

In step 840, a determination is made as to stop the agent from further monitoring the market. If monitoring is to cease, control continues to step 850 where the process stops; otherwise, control jumps back to step 810 where market activity is further monitored.

In various embodiments where the above-described systems and/or methods are implemented using a programmable device, such as a computer-based system or programmable logic, it should be appreciated that the above-described systems and methods can be implemented using any of various known or later developed programming languages, such as “C”, “C++”, “FORTRAN”, Pascal”, “VHDL” and the like.

Accordingly, various storage media, such as magnetic computer disks, optical disks, electronic memories and the like, can be prepared that can contain information that can direct a device, such as a computer, to implement the above-described systems and/or methods. Once an appropriate device has access to the information and programs contained on the storage media, the storage media can provide the information and programs to the device, thus enabling the device to perform the above-described systems and/or methods.

For example, if a computer disk containing appropriate materials, such as a source file, an object file, an executable file or the like, were provided to a computer, the computer could receive the information, appropriately configure itself and perform the functions of the various systems and methods outlined in the diagrams and flowcharts above to implement the various functions. That is, the computer could receive various portions of information from the disk relating to different elements of the above-described systems and/or methods, implement the individual systems and/or methods and coordinate the functions of the individual systems and/or methods related to AVM-related services.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1-31. (canceled)

32. A computer-based system for performing property-related searches based on search parameters provided by a user, the computer-based system comprising:
an input device configured to receive one or more user-provided search parameters relating to residential properties; and
a query device configured to generate at least a first report for the user based on the user-provided search parameters, wherein the first report contains at least one of a respective AVM value and a differential valuation for each of a plurality of residential properties that conforms to the user-provided search parameters, a differential valuation being a difference between an AVM value and a respective offering price of a residential property.

33. The computer-based system of claim 32, wherein the first report contains a respective AVM value for each of a plurality of residential properties that conforms to the user-provided search parameters.

34. The computer-based system of claim 33, wherein the first report contains a respective AVM value and offering price for each of a plurality of residential properties that conforms to the user-provided search parameters.

35. The computer-based system of claim 32, wherein the first report contains a respective differential valuation for each of a plurality of residential properties that conforms to the user-provided search parameters.

36. The computer-based system of claim 32, wherein the user-provided search parameters includes one or more parameters related to a differential valuation amount or differential valuation percentage.

37. The computer-based system of claim 32, wherein the user-provided search parameters includes identifying a first geographic region containing a plurality of residential properties for sale.

38. The computer-based system of claim 31, wherein the computer-based system is configured to first receive and store the user-provided search parameters, and wherein the query device is configured to thereafter generate a plurality of separate reports at different times with each report containing at least one of a respective AVM value and a differential valuation for each of a plurality of residential properties that conforms to the user-provided search parameters.

39. The computer-based system of claim 33, wherein the computer-based system is configured to first generate a plurality of AVM values for respective properties offered for sale in a defined geographic region, then provide at least one report to a set of subsequently sent user-provided search parameters relating to residential properties offered for sale.

40. The computer-based system of claim 33, wherein at least one AVM-generated value of the first report is provided using a large AVM database containing AVM-generated values for properties offered for sale in a first geographical area specified by the user.

41. The computer-based system of claim 32, further comprising a notification device configured to notify the user about an availability of a query report via at least one communication conduit specified by the user.

42. The computer-based system of claim 41, wherein the notification device is configured to communicate with the user using at least one of an audio message on a telephone, an automated facsimile message, email and a pager message.

43. The computer-based system of claim 32, further comprising an information device configured to provide detailed information about conforming properties to the user.

44. The computer-based system of claim 43, wherein the information device is configured to provide the detailed information via at least one of e-mail, phone and facsimile.

45. The computer-based system of claim 43, wherein computer-based system is configured to provide detailed information to the user using a map, wherein information about at least a first conforming property is embedded in the map using an icon appropriately placed on the map.

46. The computer-based system of claim 45, wherein detailed information further includes information about a plurality of comparable properties of the first conforming property.

47. The computer-based system of claim 46, wherein each comparable property representation includes an icon appropriately placed on the map.

48. The computer-based system of claim 32, wherein each AVM value or differential valuation is generated without information provided by the user.

49. The computer-based system of claim 32, wherein the one or more user-provided search parameters includes at least one parameter relating to residential properties specifically offered for sale.

50. The computer-based system of claim 49, wherein the one or more user-provided search parameters includes one or more parameters relating to offering prices of residential properties specifically offered for sale.

51. An on-line computer-based system for performing property-related searches over the internet based on search parameters provided by a user at a remote terminal, the computer-based system comprising:
an input device configured to receive one or more user-provided search parameters relating to residential properties; and
a query means for generating reports based on the user-provided search parameters, wherein each report contains an AVM-generated information item for each residential property of a set of residential properties that conforms to the user-provided search parameters;
wherein each an AVM-generated information item is generated without information provided by the user.

52. The computer-based system of claim 51, wherein the query means is configured to act in an agent mode of operation.

53. The computer-based system of claim 51, wherein the query means is configured to act in an on-line mode of operation.

54. The computer-based system of claim 51, wherein the user is a prospective buyer of properties and not a real estate professional.

55. The computer-based system of claim 51, wherein each AVM-generated information item generated without information provided by the user.

56. A storage medium containing a number of instructions that when accessed by a computer-based system can enable the computer-based system to perform real-estate related services for a user, the storage medium including:
a first set of one or more instructions directed to receiving one or more user-provided search parameters relating to residential properties; and
a second set of one or more instructions directed to generating reports based on the user-provided search parameters, wherein each report contains an AVM-generated information item for each residential property of a set of residential properties that conforms to the user-provided search parameters.

57. The storage medium of claim 56, further comprising an AVM database containing respective AVM generated values for a plurality of residential properties offered for sale;

58. The storage medium of claim 57, wherein each of the AVM generated values in the AVM database is prepared without information provided by the user.
